(19) United States
(12) Patent Application Publication
(10) Pub. No.: US 2024/0085604 A1
(43) Pub. Date: Mar. 14, 2024

(54) OPTICAL SYSTEM FOR PERISCOPE CAMERA MODULE

(71) Applicant: Schott AG, Mainz (DE)

(72) Inventors: Ralf Biertümpfel, Mainz-Kastel (DE); Frank-Thomas Lentes, Bingen (DE)

(73) Assignee: Schott AG, Mainz (DE)

(21) Appl. No.: 18/512,256

(22) Filed: Nov. 17, 2023

Related U.S. Application Data
(63) Continuation of application No. PCT/EP2022/063150, filed on May 16, 2022.

(30) Foreign Application Priority Data
May 17, 2021 (DE) 10 2021 112 723.8
May 16, 2022 (WO) PCT/EP2022/063150

(51) Int. Cl. G02B 5/20; G02B 5/22; G02B 5/28; G02B 13/00; G02B 23/08; H04N 23/55

(52) U.S. Cl. CPC G02B 5/208; G02B 5/226; G02B 5/28; G02B 13/0065; G02B 23/08; H04N 23/55

(57) ABSTRACT

An optical system for a camera module includes: an image sensor; and an optical arrangement defining a beam path, the optical arrangement including a plurality of optical components including a first prism and an optical lens system, the plurality of optical components being arranged in the beam path in a sequential order relative to one another and in front of the image sensor, the sequential order being such that the first prism is positioned before the optical lens system, at least one of the plurality of optical components including at least one absorption filter.

### CROSS REFERENCE TO RELATED APPLICATIONS

This is a continuation of PCT application no. PCT/EP2022/063150, entitled “OPTICAL SYSTEM FOR PERISCOPE CAMERA MODULE”, filed May 16, 2022, which is incorporated herein by reference. PCT application no. PCT/EP2022/063150 claims priority to German patent application no. 10 2021 112 723.8, filed May 17, 2021.

### BACKGROUND OF THE INVENTION

### 1. Field of the Invention

The present invention relates to an optical system, and, more particularly, to an optical system for a camera module.

### 2. Description of the Related Art

So-called periscope cameras are sometimes installed in smart phones and include a reflection prism which captures the image to be photographed at the smart phone rear side through an opening and deflects it by 90°, bundles it, and passes it on through an optical arrangement to the sensor, which captures the data. The optical arrangement furthermore typically includes an optical lens system (also called an objective) and optionally a further prism, which causes a further 90° deflection onto the sensor.

The general structure of optical systems of such periscope cameras is described in detail, for example, in U.S. Pat. No. 10,908,387 B2 and US 2021/0124145 A1 US. US 2021/0026117 A1 discloses an optical system including a first prism, which deflects the incident light by 90°, a lens system, and a second prism, which results in a further 90° deflection of the light beam. The light is subsequently guided through an infrared blocking filter—referred to hereinafter as “IR blocking filter”—before it is incident on the image sensor.

Such periscope cameras include one or two more optical components in comparison to conventional smart phone cameras due to their general structure.

The installation of IR blocking filters is required both in periscope cameras and in conventional digital color camera systems. Image sensors are typically known to have the property that the pixels of the sensor are also sensitive in the infrared spectral range. The optics of camera modules, the optical components of which are manufactured from common glasses or plastics, also generally still have a certain degree of infrared transmittance. Infrared light reaching the sensor results in disadvantageous effects on the imaging quality, however, since color distortions and brightness distortions can occur.

For this reason, camera modules are typically equipped with IR blocking filters, which are in particular placed directly in front of the sensor. IR blocking filters are, for example, interference filters or filter glasses which are to prevent the incidence of infrared light on the sensor. Suitable blocking filters have a high degree of transmittance in a first wavelength range (transmission range), for example from 430 to approximately 650 nm, and a very low transmittance in another wavelength range, for example, of greater than 700 nm. Furthermore, filters which have a steep edge, i.e., rapid drop of the transmittance at the UV range from less than 400 nm, can also be used. Blocking of the UV range is advantageous here to ensure better color recognition.

As described above, IR blocking filters are typically placed directly in front of the sensor. The demand for very thin filters is rising due to the components for electronic devices, such as smart phone cameras, which are becoming smaller and smaller. Thicknesses of 0.1 to 0.3 mm are typical here. To achieve a sufficient filter effect nonetheless, the components, for example filter glasses, have to be more strongly colored using the coloring components (for example, CuO). Various disadvantages can be linked thereto. Among others, problems in the production of glasses having a high CuO proportion are to be mentioned here, since CuO not only acts as a coloring component in this case, but also has effects on the glass microstructure and other physical properties of the glass as a glass component. Furthermore, such filters can have a disadvantageous signal-to-noise ratio and can result in a worse image quality. Furthermore, such very thin filter elements naturally have a comparatively low mechanical stability.

What is needed in the art is an optical system for a camera module which at least partially remedies the disadvantages of the previous camera modules.

### SUMMARY OF THE INVENTION

The present invention relates to an optical system for a camera module, in particular for a periscope camera, including an optical arrangement and an image sensor.

The present invention provides an optical system for a camera module, including an image sensor and an optical arrangement defining a beam path, wherein the optical components contained therein are arranged in the beam path in the following sequence in front of the image sensor:
(a) a first prism,
(b) optionally a first planar optical element,
(c) an optical lens system,
(d) optionally a second planar optical element,
(e) optionally a second prism, and
   wherein at least one of the components (a), (b), (d), and (e) includes at least one absorption filter.

The present invention furthermore relates to a periscope camera module including the optical system according to the present invention.

It has been found that such an optical system overcomes the disadvantages of the known systems. The placement of an absorption filter, such as an IR blocking filter, directly in front of the image sensor can thus be omitted here, and a component having corresponding absorbing effect can be placed at a position in the camera module at which it can have larger dimensions. In this way, a longer beam path results through this absorbing component than through conventional, very thinly formed filters. This enables the use of a filter which has advantageous properties regarding the ratio of blocking to transmittance, the so-called signal-to-noise ratio.

The following difference is defined to describe the ratio between transmittance and blocking, for example, for an IR blocking filter:

$$ΔΘ = {log}_{10} ( {log}_{10} ( \frac{1}{{τ}_{i , min NIR}} ) ) - {log}_{10} ( {log}_{10} ( \frac{1}{{τ}_{i , max VIS}} ) )$$

wherein
τ_{i,minNIR} is the minimum internal transmittance in the near infrared range (700 nm to 1100 nm),
τ_{i,maxVIS} is the maximum internal transmittance in the visible range (430 nm to 565 nm), ΔΘ is the difference of the spectral Diabatie, as defined in ISO 23364:2021-04 and DIN 58131:2016-11.

In very thin absorption filters, a blocking filter, for example a filter glass, has to be very strongly doped, for example using a coloring component such as CuO, in order to achieve a high level of blocking of the undesired radiation. Such filter glasses having high doping have a comparatively low ΔΘ, however, and thus an unfavorable signal-to-noise ratio.

Absorption filters, for example filter glasses, having lower doping have a significantly higher ΔΘ. However, due to the low doping, the use of absorption filters having a greater filter thickness is necessary for sufficient blocking of the undesired radiation, which are not suitable for current smart phone cameras due to their size, however. It has been found that this problem is solved by the optical system according to the present invention in that the use of a necessarily very thin absorption filter directly in front of the image sensor is eliminated and one or more components having corresponding blocking effect are installed at another position in the optical arrangement, which can have a greater thickness due to the space available there. Deflection prisms, which are produced according to one embodiment of the present invention from an absorbing filter material such as a blue glass, thus have a significantly longer optical path than the previous absorption filter which is placed in front of the sensor. While presently a typical absorption filter is only 0.1 mm to 0.3 mm thick, the optical path length through a filtering prism is up to several millimeters long. This applies similarly to embodiments in which at least one planar optical element is used as a blocking filter, which can have a greater thickness of, for example, at least 0.5 mm due to the selected position. A higher ΔΘ, and thus also an optimized signal-to-noise ratio, result therefrom for the absorption-filter including components according to the present invention.

At least one of the optical components (a), (b), (d), and (e) therefore optionally has a ΔΘ of greater than 2.0, optionally greater than 2.2, and optionally greater than 2.4 and likewise optionally greater than 2.5.

The expression “beam path” in the meaning of the present invention designates the sum of all beam paths which pass through the optical arrangement to the image sensor and contribute here to the generation of the image. The optical components of the optical arrangement according to the present invention are arranged such that light which is conducted to the sensor passes through these optical components.

The optical system according to the present invention includes at least one first prism, which deflects the incident light to the extent required for the optical design, optionally by 90°, and in the direction of the optical lens system. After the passage through the lens system, it can be deflected by a second prism onto the image sensor, optionally by a further 90°, or conducted directly thereto. The first and second prism according to the present invention is a beam deflection element, optionally a triangular prism or a prism in a shape which is based on a triangular prism. In the meaning of the present invention, this means that the prism optionally has the cross section of a triangle, optionally the cross section of an isosceles triangle. The deflection of the incident light optionally takes place at one or more boundary surfaces, optionally a boundary surface back into the interior of the prism. In one advantageous embodiment, the optical system only includes one first prism in order to ensure the most compact and space-saving possible construction of the camera module. Furthermore, the optical system according to the present invention can contain further optical components, in particular a first and/or a second planar optical element, optionally a first or a second planar optical element, particularly optionally a first planar optical element. The first planar optical element is placed in the beam path between the first prism and the lens system, and the second planar optical element is installed in the beam path between the optical lens system and the optional second prism or alternatively between the optical lens system and the image sensor. In this embodiment, the first and/or the second planar optical element includes at least one absorption filter.

It is obvious that the optional second planar optical element optionally only includes at least one absorption filter in the embodiments in which the second planar optical element is not placed directly in front of the image sensor.

A further aspect of the present invention therefore relates to an optical system for a camera module, including an image sensor and an optical arrangement defining a beam path, wherein, in the beam path, the optical components contained therein are arranged in the following sequence in front of the image sensor:
(a) a first prism,
(b) optionally a first planar optical element,
(c) an optical lens system,
(d) optionally a second planar optical element,
(e) optionally a second prism, and
   wherein at least one of the components (a), (b), (d), and (e) includes at least one absorption filter, and/or wherein the component (d) can include at least one absorption filter if the optical system includes the component (e).

A further aspect of the present invention relates to an optical system for a camera module, including an image sensor and an optical arrangement defining a beam path, wherein, in the beam path, the optical components contained therein are arranged in the following sequence in front of the image sensor:
(a) a first prism,
(b) optionally a first planar optical element,
(c) an optical lens system,
(d) optionally a second planar optical element,
(e) optionally a second prism, and
   wherein at least one of the components (a), (b), and (e) includes at least one absorption filter and wherein the component (d) can include at least one absorption filter.

In one optional embodiment, the optical arrangement according to the present invention only includes one planar optical element, optionally a first planar optical element. Multiple advantages are linked thereto. On the one hand, the space requirement of the camera module is reduced; furthermore the production costs are reduced in relation to an arrangement having two planar components. Optical problems could also be avoided, which can arise if optical elements are installed in the arrangements after the lens system. These optical problems can result since these additional optical components have to be taken into consideration in the design of the optical lens system. This accordingly applies similarly to the optional second prism.

According to the present invention, at least one of the optical components (a) first prism, (e) second prism, (b) first planar optical element, and (d) second planar optical element includes at least one absorption filter. In some advantageous embodiments, two or more, for example two, three, or four of the mentioned optical elements (a), (b), (d), and (e) can also include at least one absorption filter.

Optionally, at least one of the optical components (a), (b), and (e) includes at least one absorption filter.

Absorption filters in the meaning of the present invention are optical elements which are arranged in the beam path so that light beams that are detected by the sensor pass through this element, wherein the transmittance of the optical element is significantly lower with regard to the wavelength interfering in the image generation than for other wavelengths which are supposed to reach the sensor.

The at least one absorption filter is optionally an IR blocking filter, optionally an NIR blocking filter and/or a UV blocking filter, particularly optionally an NIR blocking filter.

Near infrared (NIR) in the meaning of the present invention optionally designates a wavelength range from 650 to 1200 nm. UV in the meaning of the present invention optionally designates a wavelength range of less than 400 nm, optionally less than 420 nm. It is fundamentally conceivable to use a component coated with an interference filter as a component blocking a specific wavelength range. Such interference filters use reflection, however, to block undesired radiation, due to which ghost images occur in particular due to the reflections. For high-quality digital color cameras, the use of absorption filters having NIR or UV blocking effect is therefore advantageous, since this reduces the risk of ghost images and scattered light.

The length of the beam path through the optical component including at least one absorption filter is optionally greater than 0.5 mm, optionally greater than 0.6 mm, optionally greater than 0.7 mm, and optionally greater than 0.8 mm. In embodiments in which the first and/or second prism include at least one absorption filter, the beam path through the components in optional embodiments is furthermore greater than 1.3 mm, optionally greater than 1.5 mm, furthermore optionally greater than 1.8 mm, furthermore optionally greater than 2.0 mm, and likewise optionally greater than 3.0 mm or greater than 4.0 mm.

The first and/or the second prism optionally has a cathetus length of greater than 1.0 to 10 mm, optionally greater than 1.3 to 7 mm, optionally greater than 1.5 to 6 mm, optionally greater than 1.8 to 5 mm.

The first and/or the second planar element optionally has a thickness of greater than 0.5 to 2.5 mm, optionally greater than 0.6 to 2.0 mm, optionally greater than 0.8 to 1.5 mm, optionally greater than 0.5 to 1.0 mm.

In the optical system according to the present invention, the at least one NIR blocking filter is optionally an NIR-absorbing filter glass, optionally at least one glass doped with Cu ions, also referred to as blue glass hereinafter, which optionally has a refractive index n_{d} of at least 1.50, furthermore optionally at least 1.55, furthermore optionally not more than 1.7, optionally less than 1.7, furthermore optionally not more than 1.65, furthermore optionally not more than 1.6. The refractive index n_{d} is known to a person skilled in the art and designates in particular the refractive index at a wavelength of approximately 587.6 nm (wavelength of the d line of helium). The glasses doped with Cu ions according to the present invention are in one optional embodiment CuO-containing phosphate glasses, wherein the CuO content is optionally in the range of 1 to 15 wt. %, optionally in the range of 2 to 10 wt. %, furthermore optionally in the range of 2.5 to 5 wt. %, or CuO-containing fluorophosphate glasses, wherein the CuO content is optionally in the range of 0.1 to 10 wt. %, optionally in the range of 0.3 to 6.5 wt. %. Such CuO-containing glasses are described, for example, in US 2018/0312424 A1, US 2012/0165178 A1, US 2006/0111231 A1, US 2016/0363703 A1, and US 2007/0099787 A1.

In a further optional embodiment, the NIR-absorbing filter glass is a highly refractive glass doped with Cu ions having a refractive index n_{d} of at least 1.70, optionally a CuO-containing glass having a lanthanum-borate glass matrix. Such glasses are described, for example, in WO 2020/006770 A1.

UV blocking filters are optical components which have a significantly lower transmittance for a first wavelength range of up to 400 nm, optionally up to 420 nm, than for a second wavelength range from 400 nm or optionally 420 to 650 nm. In one optional embodiment of the present invention, the at least one UV blocking filter is a UV absorbing glass.

UV blocking filters are optionally glasses which have a steep UV edge in the range around 400 nm. Suitable glasses are, for example, GG395, GG400, GG420, and GG435 from Schott.

In some advantageous embodiments, the use of a component designed as a UV blocking filter can be omitted according to the present invention in the optical arrangement. This is true, for example, if the optical component including an NIR blocking filter, for example a CuO-containing glass, already includes sufficient blocking in the UV range or if at least one of the optical components (a) to (e) includes a UV blocking or UV reflecting coating, in particular an interference coating.

The respective absorption filters, optionally the NIR absorbing and UV absorbing glasses, can be selected depending on their mechanical and in particular optical properties at the respective position in the optical arrangement according to the present invention. For example, it can be advantageous to select a glass which is distinguished by a high mechanical and/or chemical resistance for the first prism, which is located in a comparatively exposed position. It can also be advantageous to select a blue glass or UV absorbing glass having the highest possible refractive index in particular for the first prism. In embodiments in which the first and/or second planar optical element is formed as an NIR blocking filter, the use of glasses having a comparatively high refractive index is not necessary. For example, CuO-containing phosphate or fluorophosphate glasses are suitable here, for example the blue glasses BG40 or BG64 from Schott.

An optical element which includes at least one absorption filter in the meaning of this invention is optionally partially or completely formed from this absorption filter. In one advantageous embodiment, at least one of the optical components (a), (b), (d), and (e), optionally at least one of the optical components (a), (b), and (e), optionally at least one of the optical components (a) and (e) is formed or consists of the corresponding absorption filter, in particular of an NIR-absorbing or UV-absorbing glass. In a further advantageous embodiment, at least one of the optical components (a), (b), (d), and (e), optionally at least one of the optical components (a), (b), and (e), optionally at least one of the optical components (a) and (e) is a composite, including two or more optical composite components, wherein at least one of the optical composite components is formed or consists of the corresponding absorption filter, in particular of an NIR absorbing or UV absorbing glass.

The optical components (a), (b), (c), (d), and (e) can furthermore be at least partially coated with at least one optical layer. It is obvious in this case that a coating of the surfaces of the respective optical components is meant here. A partial coating in the meaning of the present invention represents both a coating of only one of multiple different surfaces of an optical component and also only the partial coating of one or more specific surfaces of an optical component.

Suitable optical layers are, for example, interference filter layer systems, anti-reflective layer systems, reflective layer systems (for example, metallic coatings such as Al or Ag layers), and layer systems which can improve the mechanical and/or chemical resistance of the respective component. Layer systems in the meaning of the present invention designate both individual layers and also multilayered coatings, including two or more layers. Of course, it is also conceivable to apply layer systems which represent a combination of the above-mentioned layer systems, for example an interference filter layer which increases the mechanical or chemical resistance and/or has an antireflective effect. Such layers are generally known to a person skilled in the art.

In advantageous embodiments, at least one surface of the first prism and/or the optional second prism is provided with a reflective coating, which is advantageously applied to the boundary surface of the first and/or second prism, which deflects the incident light back into the interior of the respective prism.

As already described above, the respective optical components of the optical arrangement according to the present invention includes multiple surfaces. In one optional embodiment, at least all optically relevant surfaces of a component are provided at least partially, optionally completely with a suitable optical coating. An optically relevant surface of a component in the meaning of the present invention is understood as any surface which lies in the beam path of the light, which includes both the surface on the light incident side and also the surface on the light exit face and also surfaces which reflect or deflect the incident light beam. The various optically relevant surfaces can of course—if expedient—be provided with different optical coatings.

In one optional embodiment, at least one of the components (a) and (e) includes at least one absorption filter. That is to say, the first prism and/or the optional second prism contain at least one absorption filter. In embodiments which only include a first prism, of course, the first prism includes at least one absorption filter, optionally an NIR blocking filter. In embodiments including both the first prism and the second prism, both prisms can also include at least one absorption filter. However, it is optional in this case that the first prism and the second prism include different absorption filters, for example, the first prism an NIR blocking filter and the second prism a UV blocking filter.

In another optional embodiment, at least one of the components (b) and (d) includes at least one absorption filter. That is to say, at least the first planar optical element or the second planar optical element contains at least one absorption filter, optionally an NIR blocking filter. In embodiments which only include a first or a second planar optical element, only the provided planar optical element includes at least one absorption filter. In embodiments including both the first and the second planar optical element, both planar optical elements can also include at least one absorption filter. However, it is optional in this case that the first and the second planar optical element include different absorption filters, for example the first planar optical element an NIR blocking filter and the second planar optical element a UV blocking filter.

In one particularly optional embodiment, the optical arrangement according to the present invention includes a first prism, an optical lens system, and optionally a second prism; optionally it consists of the optical components first prism, optical lens system, and optional second prism; furthermore the optical arrangement optionally consists of a first prism and a lens system. In other words, the optical arrangement according to the first embodiment only includes a first prism, a lens system, and optionally a second prism which are arranged in front of the sensor. In this embodiment, the first prism and/or the second prism—if included, optionally the first prism—includes at least one absorption filter, wherein it is optionally an NIR blocking filter and/or a UV blocking filter, optionally an NIR blocking filter. In addition to the above-mentioned advantageous effects which were mentioned with a longer beam path through optical components including at least one absorption filter, it is furthermore advantageous in this embodiment that in comparison to conventional (periscope) camera modules, an optical component is less necessary. As a result, deflection prism and absorption filter component can be implemented in a single optical component. An even more compact construction of the camera module is thus enabled, and in addition the production costs can be reduced.

In a second optional embodiment, the optical arrangement includes a first prism, a first planar optical element, and/or a second planar optical element, optionally a first or a second planar optical element, particularly optionally a first planar optical element, an optical lens system, and optionally a second prism. In this embodiment, the first and/or the second planar optical element optionally includes at least one absorption filter, wherein it is optionally an NIR blocking filter and/or a UV blocking filter, optionally an NIR blocking filter.

The optical arrangement of this embodiment optionally consists of a first prism, a first planar optical element, including at least one absorption filter, optionally an NIR blocking filter, an optical lens system, and optionally a second prism. In one embodiment, the first and/or the second prism can include at least one absorption filter, optionally a UV blocking filter, but in one optional embodiment the first and the optional second prism do not include an absorption filter.

The optical arrangement of this embodiment also optionally consists of a first prism, a first planar optical element, including at least one absorption filter, optionally a UV blocking filter, an optical lens system, and optionally a second prism.

The optical arrangement of this embodiment also optionally consists of a first prism, a first planar optical element, including at least one absorption filter, optionally an NIR blocking filter, an optical lens system, and optionally a second prism.

In a third optional embodiment, at least one of the optical components (a), (b), (d), and (e) in the optical arrangement according to the present invention represents a composite made of at least two, for example also three or four composite components, wherein at least one of the composite components includes at least one absorption filter. The individual composite components can be connected to one another by way of optical contact bonding or by an optical cement or an optically clear adhesive.

In one embodiment, the first and/or the second prism, optionally the first prism, is designed as such a composite, referred to hereinafter as a “composite prism”. A prism-shaped composite component is, for example, connected here to one or more than one, for example, two or three planar composite components, referred to hereinafter as “first” or “second” or “third planar composite component”, respectively.

At least one of the composite components includes at least one absorption filter. In one optional embodiment, all composite components include at least one absorption filter. In another optional embodiment, the composite furthermore includes at least one composite component which does not include an absorption filter in the meaning of the present invention, for example, a glass having a high refractive index, in particular a glass having a refractive index n_{d} of 1.6 to 2.2. A composite thus obtained is furthermore designated in the meaning of the present invention as the “first prism” or “second prism”.

In one embodiment of the optical arrangement, the first and/or the second planar optical element can additionally or alternatively be embodied as a composite. Such a composite is furthermore designated as a “first planar optical element” or “second planar optical element”. In this case, this is advantageously a composite made of two composite components which include different absorption filters, for example, a composite of a first planar component which includes a UV blocking filter and a second planar component which includes an NIR blocking filter.

Of course, such composites can also include one or more optical coatings as described above.

The optical lens system in the optical arrangement according to the present invention can be a single optical lens or optionally an arrangement including two or more optical lenses. Color defects and distortions in the image can be avoided by the combination of different individual lenses in the optical lens system. Details of exemplary designs of the optical lens system are known to a person skilled in the art and are found, inter alia, in the prior art cited at the outset.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIGS. 1, 2, and 3 show various embodiments of the optical system according to the present invention; and

FIGS. 4A, 4B, 4C, 4D, 4E, 4F, and 4G show various embodiments of a first or second prism designed as a composite according to the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

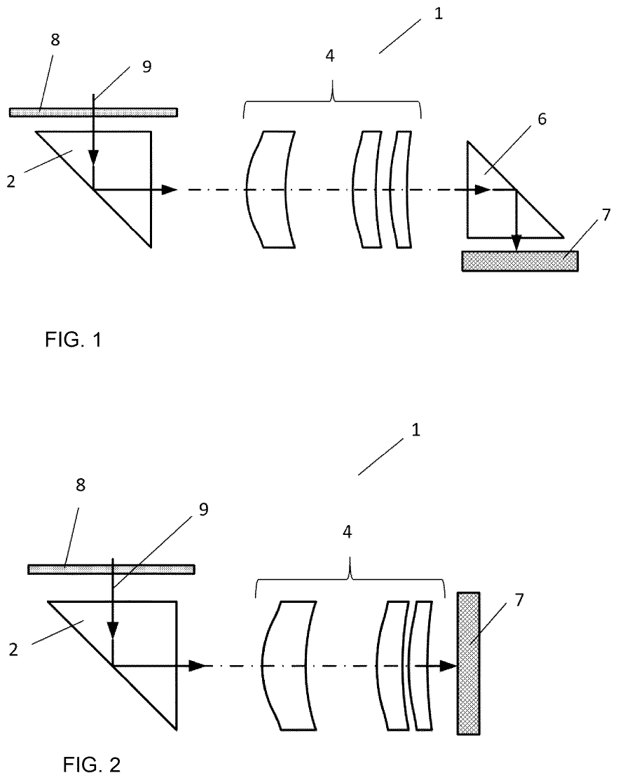

FIG. 1 shows an optional embodiment of the optical system according to the present invention. In FIGS. 1 to 3, the beam path 9 solely schematically designates the path of the light (main beam) along the optical axis. It is obvious that the beam path of a specific field half-angle or a specific wavelength is not shown here. The path of the incident light through the protective window 8 in the optical arrangement of the camera module 1 is shown first to the one first prism 2, which deflects the beam path 9 of the light by 90°. The first prism 2 is designed in this embodiment as an absorption filter, optionally a blue glass, which acts as an NIR filter. Accordingly, at least a part of the NIR radiation contained in the incident light is absorbed on the path of the light through the first prism 2. As described, the light is deflected by 90° by the first prism 2, so that it subsequently passes through the optical lens system 4, which is shown here having three lenses solely by way of example and is deflected by a further 90° by the second prism 6, due to which the light is incident on the sensor 7. The second prism 6 can also include an absorption filter here, for example an NIR filter or a UV blocking filter. If the second prism 6 includes an absorption filter, it is optionally a UV blocking filter. In optional embodiments, the second prism 6 does not include an absorption filter, however. Both the first prism 2 and the second prism 6 and also one or more individual lenses of the optical lens system 4 furthermore optionally include optical coatings (not shown). These optical coatings are optionally located on all optically relevant surfaces of the coated optical components.

FIG. 2 shows a second embodiment of the camera module 1 according to the present invention. If not described otherwise, the explanations mentioned in conjunction with FIG. 1 apply to the individual components and reference signs. The camera module 1 shown in FIG. 2, in contrast to the module described in FIG. 1, only includes a first prism 2, but no second prism 6, the light thus only experiences one 90° deflection and is incident directly on the sensor 7 after the passage of the optical lens system 4. This optical arrangement is even more compact due to the absence of a second prism 2.

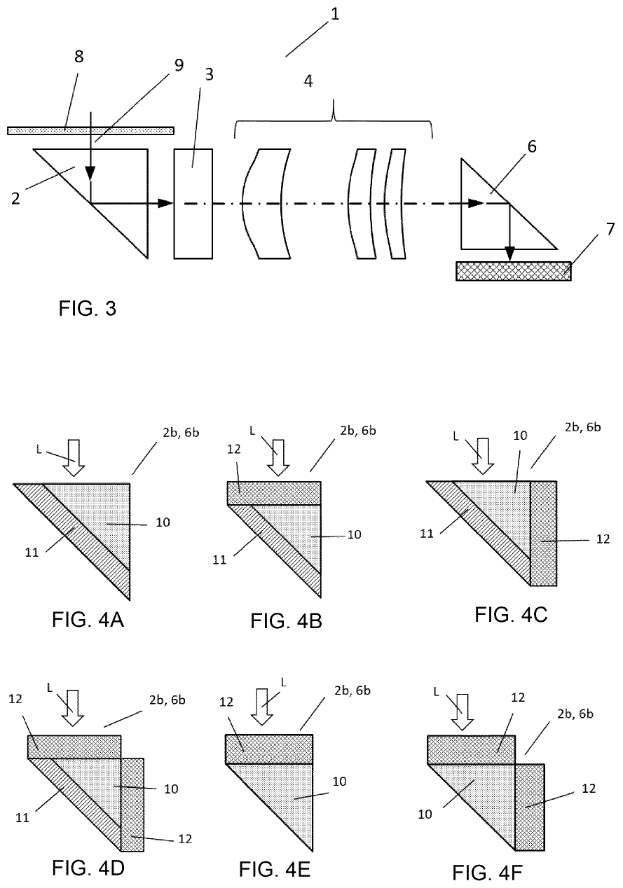

FIG. 3 shows a third embodiment of the camera module 1 according to the present invention. If not described otherwise, the explanations mentioned in conjunction with FIG. 1 and FIG. 2 apply to the individual components and reference signs. The illustrated optical arrangement includes a first prism 2 and a first planar optical element 3, as well as a lens system 4 followed by a second prism 6 and the image sensor 7. Alternatively thereto, the second prism 6 can be omitted in one optional embodiment. Accordingly, in this alternative embodiment the light is incident, after the passage through the optical lens system 4, directly without further deflection on the sensor 7 placed behind it. This embodiment is particularly advantageous due to the even more compact construction. In the illustrated embodiment and the mentioned alternative embodiment, the first planar optical component includes an absorption filter, in particular an NIR blocking filter. The prisms 2 and/or 6 can in some embodiments also include an absorption filter, but this is optionally not the case.

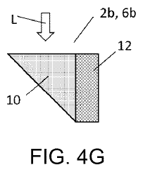

FIGS. 4A to 4G show various exemplary embodiments of first or second prisms designed as a composite, referred to hereinafter as first composite prism 2a or second composite prism 6a. First and second composite prism 2a, 6a are each constructed from a prism-shaped composite component 10 and at least one first planar composite component 11 and/or at least one second planar composite component 12. L designates the light incident on the prism 2a or 6a. The prism-shaped composite component 10, the first planar composite component 11, and the second planar composite component 12 are optionally different from one another. For example, the composite component 10 can include a UV blocking filter, the first planar component 11 can include a glass having a high refractive index, which does not include an absorption filter, and the second planar component 12 can include an NIR blocking filter.

FIG. 4A shows a composite prism 2b, 6b which includes a prism-shaped composite component 10 and a first planar composite component 11 attached to its hypotenuse. In one optional embodiment, an NIR blocking filter is used here as the prism-shaped composite component 10, which is connected to a planar composite component 11 made of a glass having a high refractive index, for example, having refractive index n_{d} of at least 1.6. In a further optional embodiment, the prism-shaped composite component 10 includes a UV blocking filter and the attached first planar composite component 11 includes a glass having a high refractive index.

FIG. 4B shows a composite prism 2b, 6b, which includes a prism-shaped composite component 10, a first planar composite component 11 attached to its hypotenuse, and a first planar composite component 12, which is attached to the surface facing toward the incident light, referred to hereinafter as the cathetus 1. In one advantageous embodiment, the prism-shaped composite component 10 includes an NIR blocking filter, the first planar composite component 11 includes a glass having a high refractive index, and the second planar composite component 12 includes a UV blocking filter. In another advantageous embodiment, the prism-shaped composite component 10 includes a UV blocking filter, the first planar composite component 11 includes a glass having a high refractive index, and the second planar composite component 12 includes an NIR blocking filter.

FIG. 4C shows a composite prism 2b, 6b, which differs from that shown in FIG. 4B in that the second planar composite component 12 is attached to the other cathetus, referred to hereinafter as cathetus 2. The optional embodiments for the composite components 10, 11, and 12 correspond to those mentioned in conjunction with FIG. 4B.

FIG. 4D shows a further embodiment of a composite prism 2b, 6b, which is similar to the basic structure of the composite prism shown in FIG. 4B. However, in the present case a second planar composite component 12 is attached in each case to both cathetus 1 and cathetus 2. The optional embodiments for the composite components 10, 11, and 12 correspond to those mentioned in conjunction with FIG. 4B and FIG. 4C.

FIG. 4E shows a composite prism 2b, 6b, which, in addition to a prism-shaped composite component 10, includes a second planar composite component, which is attached to cathetus 1. The optional embodiments for the composite components 10 and 12 correspond to those mentioned in conjunction with FIG. 4B and FIG. 4C.

FIG. 4F shows a further composite prism 2b, 6b which differs from that shown in FIG. 4E in that a second planar composite component 12 is also attached to cathetus 2. The optional embodiments for the composite components 10 and 12 correspond to those mentioned in conjunction with FIG. 4B and FIG. 4C.

FIG. 4G shows a further composite prism 2b, 6b which differs from that shown in FIG. 4F in that a second planar composite component 12 is only attached to cathetus 2. The optional embodiments for the composite components 10 and 12 correspond to those mentioned in conjunction with FIG. 4B and FIG. 4C. This embodiment is particularly advantageous with respect to the space requirement in camera modules, since a second planar composite component 12 on cathetus 1 is omitted.

### LIST OF REFERENCE SIGNS

1 camera module
2 first prism
2b first composite prism
3 first planar optical element
4 optical lens system
5 second planar optical element
6 second prism
6b second composite prism
7 sensor
8 protective window
9 beam path
10 prism-shaped composite component
11 first planar composite component
12 second planar composite component

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An optical system for a camera module, the optical system comprising:
an image sensor; and
an optical arrangement defining a beam path, the optical arrangement including a plurality of optical components including a first prism and an optical lens system, the plurality of optical components being arranged in the beam path in a sequential order relative to one another and in front of the image sensor, the sequential order being such that the first prism is positioned before the optical lens system, at least one of the plurality of optical components including at least one absorption filter.

2. The optical system according to claim 1, wherein the at least one absorption filter comprises at least one of at least one NIR blocking filter and at least one UV blocking filter.

3. The optical system according to claim 2, wherein the at least one NIR blocking filter comprises at least one NIR absorbing filter glass.

4. The optical system according to claim 3, wherein the at least one NIR absorbing filter glass includes at least one blue glass, which has a refractive index of at least 1.50.

5. The optical system according to claim 2, wherein the at least one UV blocking filter comprises at least one UV absorbing glass.

6. The optical system according to claim 1, wherein the plurality of optical components further includes a first planar optical element, a second planar optical element, and a second prism, the sequential order being the first prism, then the first planar optical element, then the optical lens system, then the second planar optical element, and then the second prism, wherein at least one of the plurality of optical components is at least partially coated using at least one optical layer.

7. The optical system according to claim 1, wherein the plurality of optical components further includes a second prism, the sequential order being the first prism, then the optical lens system, and then the second prism, wherein the first prism and the second prism each includes a surface, at least one of the surface of the first prism and the surface of the second prism being at least partially coated with at least one reflective layer.

8. The optical system according to claim 1, wherein the plurality of optical components further includes a second prism, the sequential order being the first prism, then the optical lens system, and then the second prism, wherein at least one of the first prism and the second prism comprises the at least one absorption filter.

9. The optical system according to claim 1, wherein the plurality of optical components further includes a second prism, the sequential order being the first prism, then the optical lens system, and then the second prism, at least one of the first prism and the second prism comprising the at least one absorption filter, wherein the first prism and the optical lens system are configured for being penetrated by an incident optical beam on the beam path to the image sensor.

10. The optical system according to claim 9, wherein the plurality of optical components consists of the first prism, the optical lens system, and the second prism, wherein the first prism, the optical lens system, and the second prism are configured for being penetrated by an incident optical beam on the beam path to the image sensor.

11. The optical system according to claim 1, wherein the plurality of optical components further includes a second prism, the sequential order being the first prism, then the optical lens system, and then the second prism, wherein the first prism or the second prism comprises the at least one absorption filter.

12. The optical system according to claim 11, wherein the at least one absorption filter comprises at least one NIR blocking filter.

13. The optical system according to claim 1, wherein the plurality of optical components further includes a first planar optical element, and a second planar optical element, the sequential order being the first prism, then the first planar optical element, then the optical lens system, and then the second planar optical element, wherein at least one of the first planar optical element and the second planar optical element comprises the at least one absorption filter.

14. The optical system according to claim 13, wherein the first planar optical element comprises the at least one absorption filter, which is at least one NIR blocking filter.

15. The optical system according to claim 1, wherein the plurality of optical components further includes a first planar optical element, a second planar optical element, and a second prism, the sequential order being the first prism, then the first planar optical element, then the optical lens system, then the second planar optical element, and then the second prism, wherein at least one of the first prism, the first planar optical element, the second planar optical element, and the second prism includes a composite made of at least two composite components, wherein at least one of the at least two composite components comprises the at least one absorption filter.

16. The optical system according to claim 15, wherein at least one of the first prism and the second prism includes the composite.

17. A periscope camera module, comprising:
an optical system, which includes:
an image sensor; and
an optical arrangement defining a beam path, the optical arrangement including a plurality of optical components including a first prism and an optical lens system, the plurality of optical components being arranged in the beam path in a sequential order relative to one another and in front of the image sensor, the sequential order being such that the first prism is positioned before the optical lens system, at least one of the plurality of optical components including at least one absorption filter.
